(19) United States
(12) Patent Application Publication
(10) Pub. No.: US 2015/0185980 A1
(43) Pub. Date: Jul. 2, 2015

(54) METHOD AND DEVICE FOR SWITCHING SCREENS

(71) Applicant: SAMSUNG ELECTRONICS CO., LTD., Gyeonggi-do (KR)

(72) Inventors: Jin Wan An, Daegu (KR); Yong Gil Han, Gyeongsangbuk-do (KR)

(21) Appl. No.: 14/586,637

(22) Filed: Dec. 30, 2014

(30) Foreign Application Priority Data
Dec. 30, 2013 (KR) 10-2013-0166604

(51) Int. Cl. G06F 3/0482; G06F 3/0481

(52) U.S. Cl. CPC G06F 3/0482; G06F 3/04817

(57) ABSTRACT

A screen switching method in an electronic device includes displaying an execution screen of a first application on a screen, displaying an event icon indicating an event occurring in association with a second application, on a portion of the first execution screen where the first application is being executed, receiving an input for the event icon, and displaying an execution screen of the first application and an execution screen of the second application simultaneously on the screen, in response to the input. Other embodiments including an electronic device for switching screens are also disclosed.

### CROSS-REFERENCE TO RELATED APPLICATION AND CLAIM OF PRIORITY

The present application is related to and claims priority under 35 U.S.C. §119 to an application No. 10-2013-0166604 filed in the Korean Intellectual Property Office on Dec. 30, 2013, the contents of which are incorporated herein by reference.

### TECHNICAL FIELD

The present disclosure relates to a method and device for effectively switching screens displayed on a display of an electronic device when an event occurs.

### BACKGROUND

Electronic devices such as smartphones support various applications. Applications may provide various functions such as Social Network Service (SNS), video playback, video recording, internet browsing, and games.

Electronic devices provide a switching function between applications. For example, a video playback application may switch to an internet application. If a number of messages relating to applications such as SMS, Facebook, Twitter, and Chat On are received sporadically during the use of an electronic device, a user may temporarily stop a running application and then check the received message or may terminate a running application (for example, terminate a game or video playback) and then check the received message.

### SUMMARY

A screen switching method in an electronic device includes displaying an execution screen of a first application on a screen, displaying an event icon indicating an event occurring in association with a second application, on a portion of the first execution screen where the first application is being executed, receiving an input for the event icon, and displaying an execution screen of the first application and an execution screen of the second application simultaneously on the screen, in response to the input.

In some embodiments, the execution screen of the second application is in a pop-up window over the execution window of the first application.

In some embodiments, the execution screen of the second application is in a split window, wherein the screen is split into the execution screen of the first application and the execution screen of the second application.

In some embodiments, a type of the execution screen of the second application is determined on the basis of at least one of a user input frequency of the first application and a number of objects on the execution screen of the first application.

In some embodiments, the execution screen of the second application is in a pop-up window when the input for the event icon is a tapping on the event icon.

In some embodiments, the execution screen of the second application is in a split window when the input for the event icon is a dragging the event icon.

In some embodiments, a split border is placed on a point where the dragging of event icon is released.

In some embodiments, the input for the event icon is a voice input instructing a type of the execution screen of the second application.

In some embodiments, receiving the input for the event icon includes receiving a first input for selecting the event icon, displaying a sub-menus comprising at least a pop-up window and a split window, adjacent to the event icon, and receiving a second input for selecting one menu from the sub-menus.

In some embodiments, a size or a position of the displayed pop-up window form is adjusted according to a user input.

In some embodiments, a split ratio of the screen is adjusted according to a user input.

In some embodiments, displaying the event icon includes analyzing an image displayed by the first application, and displaying the event icon in an area determined based on the analysis.

An electronic device includes a screen configured to display an image or a video, and a controller configured to cause the screen to display an execution screen of a first application on a screen, cause the screen to display an event icon indicating an event occurring in association with a second application, on a portion of the first execution screen where the first application is being executed, receive an input for the event icon, and cause the screen to display an execution screen of the first application and an execution screen of the second application simultaneously on the screen, in response to the input.

In some embodiments the controller is further configured to receive a first input for selecting the event icon, cause the screen to display a sub-menus comprising at least a pop-up window and a split window, adjacent to the event icon, and receive a second input for selecting one menu from the sub-menus.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A to 1C illustrate a switching operation between different applications on a screen.

FIGS. 2A to 2D illustrate the switching operations between different applications according to embodiments of the present disclosure.

FIGS. 3A to 3D illustrate the screen switching operations on the basis of characteristics of the application programs according to embodiments of the present disclosure.

FIGS. 4A to 4D illustrate the screen switching operations on the basis of a user input according to embodiments of the present disclosure.

FIG. 5 is a view illustrating the screen switching operation on the basis of a sub-menu according to an embodiment of the present disclosure.

FIGS. 6A to 6B illustrate adjusting the size of a display area of the application according to embodiments of the present disclosure.

FIGS. 7A to 7B illustrate where an event icon is displayed according to embodiments of the present disclosure.

FIG. 8 illustrates a structure of an electronic device according to an embodiment of the present disclosure.

FIG. 9 is a flowchart illustrating a screen switching method according to an embodiment of the present disclosure.

FIG. 10 is a flowchart illustrating a user input receiving method according to an embodiment of the present disclosure.

FIGS. 11A to 11B illustrate when an event occurs during the execution of a video capturing application according to embodiments of the present disclosure.

FIGS. 12A to 12B illustrate the screen switching operation according to another embodiment of the present disclosure.

### DETAILED DESCRIPTION

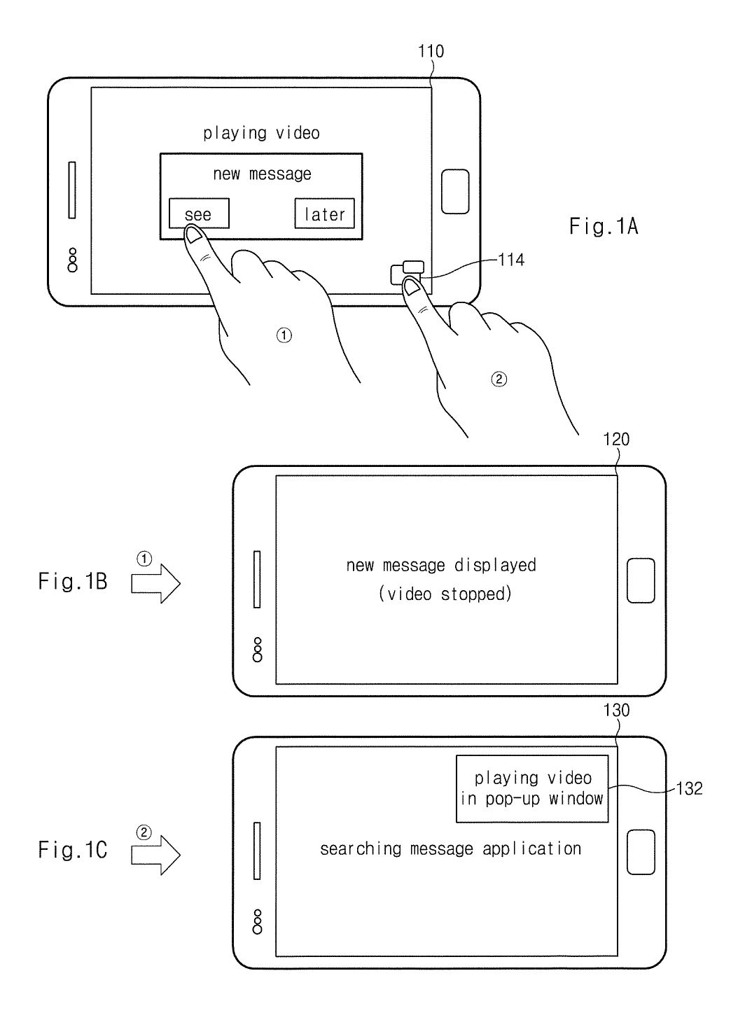

FIGS. 1 through 12B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. Hereinafter, the present disclosure will be described with reference to the accompanying drawings. In relation to the present disclosure, since various modifications are possible and thus various embodiments are provided, specific embodiments are illustrated in the drawings and related detailed descriptions are set forth in this specification. However, the present disclosure is not intended to limit specific embodiments and is understood that it should include all modifications, equivalents, and substitutes within the scope and technical range of the present disclosure. In relation to the descriptions of the drawings, like reference numerals refer to like elements.

In the disclosure of this specification, the term “include,” “comprise,” “including,” or “comprising,” specifies a corresponding function, operation or component but does not exclude other corresponding functions, operations, or components. Moreover, the term “include,” “comprise,” “including,” or “comprising,” specifies features, numbers, processes, components, parts, or combinations thereof but does not exclude other features, numbers, processes, components, parts, or combinations thereof.

As used herein, the term “or” includes any and all combinations of one or more of the associated listed items. For example, “A or B” may include “A” or “B” or may include both “A” and “B”.

In this specification, the terms “first” and “second” are used to describe various components but do not limit corresponding components. For example, the terms do not limit the order and/or importance of corresponding components. The terms are used to distinguish one component from another component. For example, a first user device and a second user device are all user devices and represent different user devices. For example, a first component may be referred to as a second component and vice versa without departing from the scope of the present disclosure.

When one part (or element, device, etc.) is referred to as being ‘connected’ to another part (or element, device, etc.), it should be understood that the former can be ‘directly connected’ to the latter, or ‘electrically connected’ to the latter via an intervening part (or element, device, etc.). On the contrary, when one part is referred to as being “directly connected” to another part, it should be understood the there is no intervening part.

Terms used in this specification are used for describing specific embodiments, and are not intended to limit the scope of the present disclosure. The terms of a singular form may include plural forms unless they have a clearly different meaning in the context.

Unless otherwise defined, all terms used herein including technical or scientific terms have the same meanings as those understood by those skilled in the art. Terms used herein that are defined in commonly used dictionaries should be interpreted as having meanings that match the meanings of the related art, and should not be interpreted as having ideal or excessively formal meanings unless otherwise clearly defined.

An electronic device according to an embodiment of the present disclosure may be a device having a communication function. For example, an electronic device may include at least one from among smartphones, tablet personal computers (PCs), mobile phones, video phones, e-book readers, desktop PCs, laptop PCs, netbook computers, personal digital assistants (PDAs), portable multimedia players (PMPs), MP3 players, mobile medical equipment, cameras, or wearable devices (for example, head-mounted-devices (HMDs) including electronic glasses, electronic clothing, electronic bracelets, electronic necklaces, accessories, electronic tattoos, or smart watches).

According to an embodiment of the present disclosure, an electronic device may be a smart home appliance having a communication function. A smart home appliance, for example, an electronic device, may include at least one from among digital video disk (DVD) players, audio systems, refrigerators, air conditioners, vacuum cleaners, ovens, microwaves, washing machines, air purifiers, set-top boxes, TV boxes (for example, the Samsung HomeSync™, Apple TV™, or Google TV™), game consoles, electronic dictionaries, electronic keys, camcorders, or electronic frames.

According to an embodiment of the present disclosure, an electronic device may include at least one from among various medical devices (for example, magnetic resonance angiography (MRA) devices, magnetic resonance imaging (MRI) devices, computed tomography (CT) devices, medical imaging devices, ultrasonic devices, etc.), navigation devices, global positioning system (GPS) receivers, event data recorders (EDRs), flight data recorders (FDRs), vehicle infotainment devices, marine electronic equipment (for example, marine navigation systems, and gyro compasses), avionics, security equipment, automotive head units, industrial or household robots, automatic teller machines (ATMs) of financial institutions, or points of sales (POS) in stores.

According to an embodiment of the present disclosure, an electronic device may include at least one from among furniture or buildings/structures having a communication function, electronic boards, electronic signature receiving devices, projectors, or various measuring instruments (such as water, electricity, gas, or radio signal measuring instruments). An electronic device according to an embodiment of the present disclosure may be one of the various above-mentioned devices or a combination thereof. Moreover, an electronic device according to an embodiment of the present disclosure may be a flexible device. Furthermore, it is apparent to those skilled in the art that an electronic device according to an embodiment of the present disclosure is not limited to the above-mentioned devices.

Hereinafter, an electronic device according to various embodiments of the present disclosure is described with reference to the accompanying drawings. The term “user” used in various embodiments may refer to a user using an electronic device or a device using an electronic device (for example, an intelligent electronic device).

FIGS. 1A to 1C illustrate switching between different applications on a screen. When one application switches to another application, the first application is terminated and the second application begins, as illustrated.

It is assumed that a video is being played on a screen 110 of FIG. 1A. When a new message arrives during playing the video, a notification 112 for the message is displayed. When a user selects a SEE button, the playback of the video stops and a new message is displayed on a screen 120, as illustrated in FIG. 1B.

In some embodiments, upon the receipt of a new message, if a pop-up play button 114 displayed on the screen 110 is selected, the video being played is continuously displayed in a pop-up area 132. In this state, a user may look up and execute a message application for checking the received message. However, in these embodiments where the pop-up play is used, switching to an application that a user desires to run can require an additional input (for example, touches) to execute the desired application without terminating a currently running application.

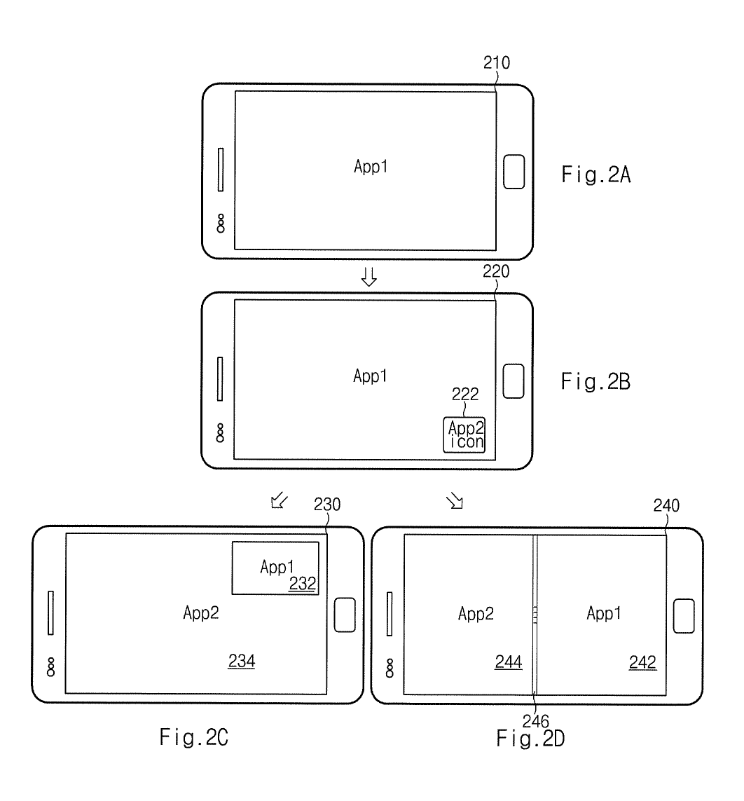

FIGS. 2A to 2D illustrate the methods of displaying different applications according to embodiments of the present disclosure.

Referring to FIG. 2A, a screen 210 displays a first running application. When an event for a second application occurs, an even icon representing the event for the second application can be displayed on a screen. A screen 220 in FIG. 2B represents a screen where the event for the second application occurs during the execution of the first application. The screen 220 is an exemplary screen and is not limited to displaying only the first application and the event icon on a screen. For example, the event icon 222 (for example, App2 icon) can be displayed together with another icon such as a pop-up play icon. The event icon 222 can be provided together with a notification in a top bar form.

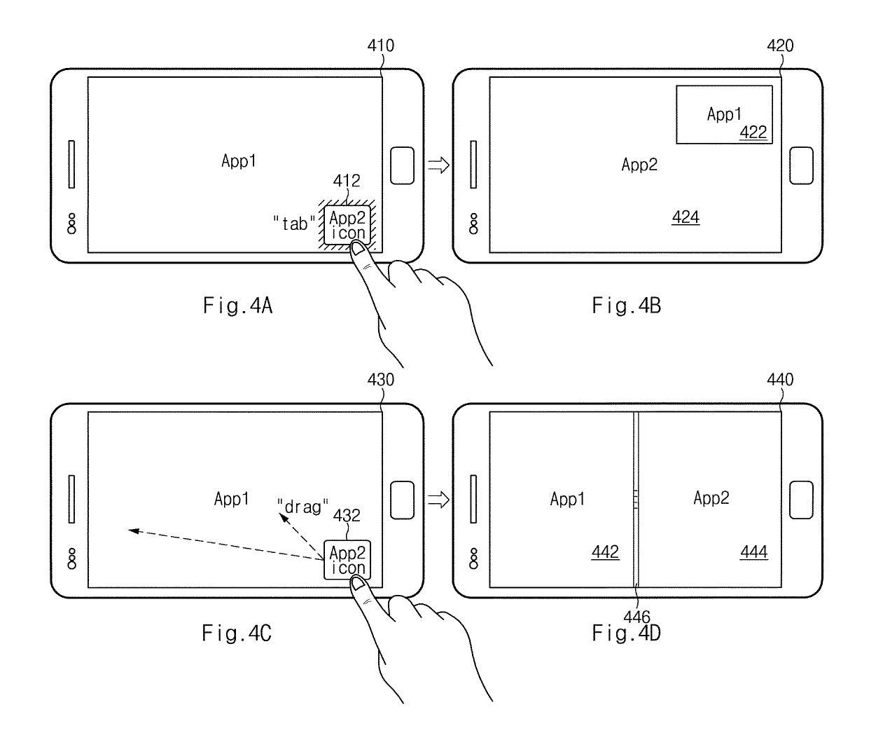

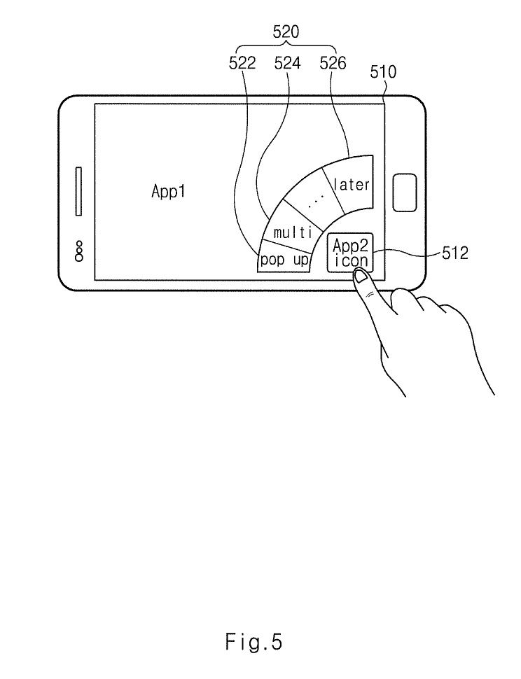

Upon receipt of a user input for the event icon 222, in response to this input, the first application and the second application can be simultaneously displayed in the form of a screen 230 or a screen 240 on different areas of a screen. A user input for the event icon 222 can be provided in various forms and this is described later with reference to FIGS. 4A to 4D or FIG. 5.

A screen 230 represents a screen where the first application is displayed in a pop-up window form. That is, the second application is displayed in a full screen and the first application is displayed overlaying the first application. As a result, the first application is displayed in an area 232 and the second application is displayed in an area 234, as illustrated in FIG. 2C.

On the basis of a device setting, user setting, a property of a running application, or other factors, an area where the first application is displayed and an area where the second application is displayed can be exchanged with each other. That is, for example, in the screen 230, the first application is displayed in the area 234 and the second application is displayed in the area 232. If the first application is a text viewer for displaying a small size font of text and the second application is an application that does not require a high resolution such as a stopwatch or a compass, it is efficient for the second application to be disposed on a pop-up window area occupying a relatively small area (for example, the area 232).

The screen 240 represents a screen where the first application and the second application are displayed in a multi-window form. The screen 240 includes an area 242 where the first application is displayed and an area 244 where the second application is displayed. Additionally, the screen 240 may or may not include a separation bar separating each window.

As mentioned above, an area where the first application is displayed and an area where the second application is displayed can be exchanged with each other. Additionally, the size of each area can also vary. The screen 240 is a multi-window configured with two windows but can be implemented with at least three multi-windows.

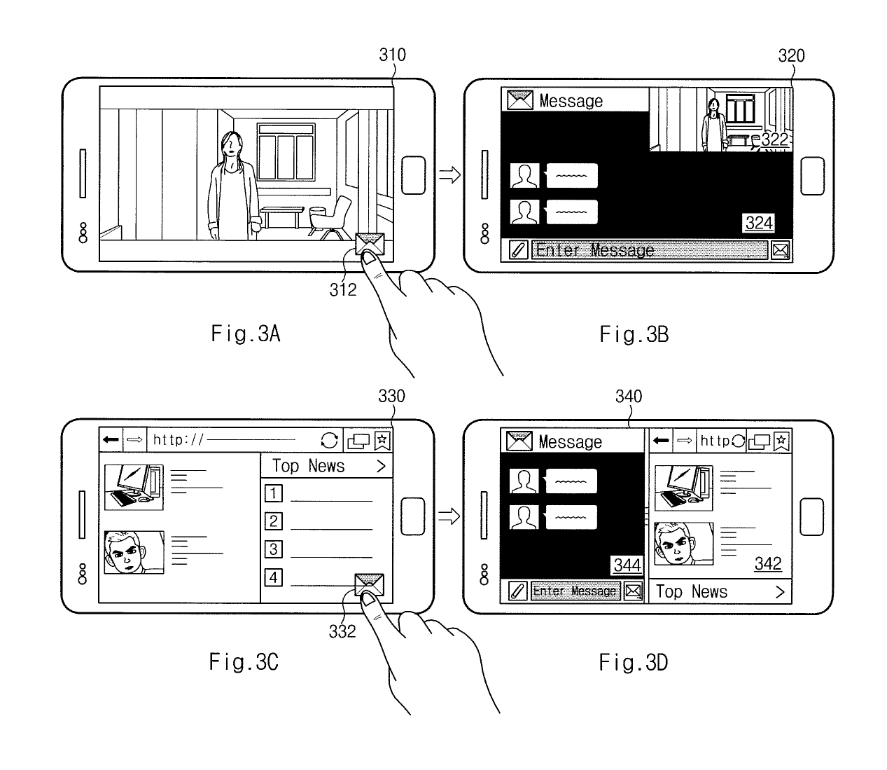

An electronic device can display the first application and the second application in a pop-up window form or a multi-window form in response to an input for an event icon. The electronic device can select one of a pop-up window form or a split-window form according to predetermined criteria. Various embodiments relating thereto are described with reference to FIGS. 3A to 3D, FIGS. 4A to 4D, and FIG. 5.

FIGS. 3A to 3D illustrate the screen switching operations on the basis of characteristics of application programs according to an embodiment of the present disclosure. Referring to FIG. 3, when an event icon for a second application is selected, screen switching in a pop-up window form and a multi-window (e.g. split-window) form is respectively exemplified.

A screen 310 in FIG. 3A represents a screen where a first application is a video playback application. If a new message is received during video playback, an event icon 312 for a message application (that is, a second application) can be displayed at the right bottom corner of a screen. In response to an input for the icon 312, the second application can be displayed.

In this case, since the first application is a video playback application that does not frequently require user inputs, the electronic device can determine a display form as a pop-up window form. That is, a message application can be displayed in an area 324 of a screen 320 and a video application can be played continuously on an area 322 of the screen 320, as illustrated in FIG. 3B. In the case of video playback, even when an application is displayed in a pop-up window, this may not cause inconvenience in viewing a video. However, if a video is played in a full screen and a message application is displayed in a pop-up window, a user can have difficulties in recognizing a message displayed in the pop-up window or in executing a keyboard. (Of course, the opposite is possible, for example, in the case of a video including subtitles).

In brief, if the first application does not require a user input frequently or mainly performs a screen based video/camera operation, a screen can switch to display the first application in a pop-up window.

According to another embodiment of the present disclosure, an object configuring a screen of the first application such as an image or text can be analyzed. The electronic device can check the amount of an object configuring a screen and display the object in a multi-window form or a pop-up window form. For example, if the number of objects configuring a screen is large, in order for a user to read or view the objects conveniently, the first application can be displayed in a multi-window instead of a pop-up window.

Such criteria can be stored in a terminal device in advance. For example, if the first application is a camera, video, clock, compass, or video call application, it can be set to be displayed in a pop-up window form.

A screen 330 in FIG. 3C represents a screen where the first application is an internet application. If a new message is received during internet surfing, an event icon 332 for a message application (that is, the second application) can be displayed at the right bottom corner of a screen. In response to an input for the icon 332, the second application can be displayed.

In this case, the first application is an internet application through which a user input occurs frequently in general. That is, a user running the internet application can continuously provide an input such as scroll, enlarge, and select. Accordingly, the electronic device can select a multi-window (i.e., split-window) form where a screen is split into multiple windows, so as to facilitate a user input. That is, the message application can be displayed in an area 344 of a screen 340, and the internet application can be displayed in an area 342 of the screen 340, as illustrated in FIG. 3D. In this case, the screen of the internet application can be reconfigured. For example, although an item “Top News” is displayed in an additional frame that is arranged vertical to the left-side articles on the screen 330, it can be arranged horizontal to corresponding articles in the area 342 and displayed on the screen 340.

Such descriptions are exemplary and the present disclosure is not limited thereto. For example, if it is evaluated that the frequency of a user input required by an internet application is not high and accordingly a message application is running simultaneously during the execution of the internet application, the internet application can be displayed in a pop-up display form.

FIGS. 4A to 4D illustrate the screen switching operations on the basis of a user input according to embodiments of the present disclosure. A user input relating to these embodiments can typically mean a capacitive touch input through, e.g., a finger, but the present disclosure is not limited thereto. For example, a user can provide an input by using a stylus pen such as an S-pen and such an input can include a resistive and optical recognition in addition to a capacitive recognition.

In relation to a screen 410, a user can provide a tap input for a displayed event icon 412. The tap input can be a double tap input. Upon receipt of an input for tapping an event icon, a screen can be switched to allow the first application to be displayed in a pop-up window form. In this case, in relation to a screen 420, the first application can be displayed in a pop-up window area 422 and the second application can be displayed in an area 424, as illustrated in FIG. 4B.

In relation to a screen 430, a user can provide a drag input for a displayed event icon 432, as illustrated in FIG. 4C. This drag input can mean a drag and drop input. For example, in the case of an input using a stylus pen, when an event icon for a second application is dragged to a predetermined position through a stylus pen while the event icon is selected, the electronic device can switch a screen so as to display the first application and the second application in a multi-window. According to another embodiment of the present disclosure, while a user selects an event icon for a second application by using a stylus pen, if the even icon is dragged to a predetermined position and released (that is, the stylus pen is withdrawn from the screen), that is, a drag and drop input occurs, in response to this, the electronic device can switch a screen so as to display the first application and the second application to be displayed in a multi-window. In this case, in relation to a screen 440, the first application can be displayed in an area 442 and the second application can be displayed in an application area 444, as illustrated in FIG. 4D. The two areas can be separated by a border line 446.

In some embodiments, split border 446 is placed on a point where the dragging of event icon is released.

An area of a window where each application is running according to a drag input can vary. For example, when the event icon 432 is dragged toward the area 442, the second application can be displayed in the area 442. Alternatively, when a point to which the event icon 432 is dragged toward the area 444, the second application can be displayed in the area 444.

FIG. 5 is a view illustrating a screen switching method on the basis of a sub menu according to an embodiment of the present disclosure.

Referring to FIG. 5, when an event icon 512 is selected by a user, a sub menu 520 can be displayed around the event icon 512. The sub menu 520 can include a pop-up window menu 522 and a multi-window menu 524. Additionally, the sub menu 520 can additionally include various menus such as a “later” menu 526. For example, when the “later” menu 526 is selected, the event icon 512 and the sub menu 520 can disappear immediately.

When the pop-up window menu 522 is selected from the sub menu 520, the first or second application can be displayed in a pop-up window form. When the multi-window menu 524 is selected from the sub menu 520, the first and second applications can be displayed in a multi-window form.

The electronic device can recognize a user input through various methods. According to an embodiment of the present disclosure, upon receipt of an input (that is, a first tap) for selecting the event icon 512, the electronic device can display the sub menu 520, and upon receipt of an input (that is, a second tap) for selecting at least one menu from the sub menu 520, a screen can be switched on this basis.

According to another embodiment of the present disclosure, upon receipt of an input for selecting (that is, contacting) the event icon 512, the electronic device can display the sub menu 520, and as the contact is moved (that is, dragged) to an area corresponding to at least one menu in the sub menu 520, a screen can be switched on this basis.

According to another embodiment of the present disclosure, the electronic device can detect a stylus disposed within a predetermined distance from a screen and can display the sub menu 520 if an area that the stylus indicates corresponds to the event icon 512. When the stylus selects (that is, contacts) one of a sub menus or indicates an area of the sub menus for a predetermined time, the electronic device can switch a screen on this basis.

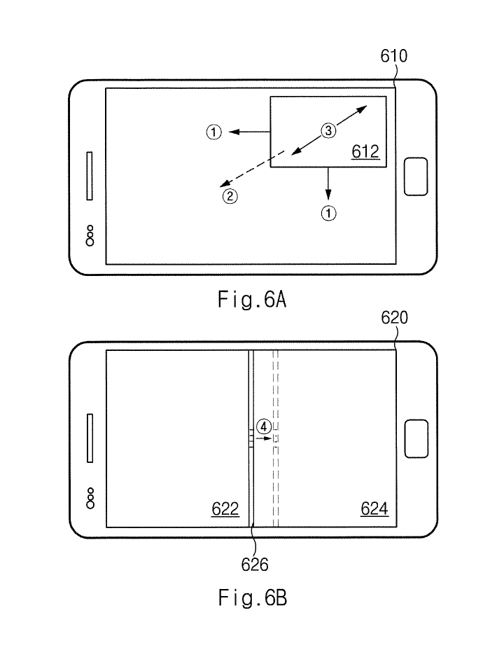

FIGS. 6A and 6B illustrate adjusting a size of a display area of the application according to an embodiment of the present disclosure.

A screen 610 represents a display in a pop-up window form. The size of the displayed pop-up window can be adjusted according to a user input. For example, when a drag input is provided in an outward direction of the window from the boundary area of the pop-up window, the boundary of the pop-up window can extend on the basis of a drag length in a corresponding direction. On the contrary, when a drag input is provided in an inward direction of the window from the boundary area of the pop-up window, an area of the pop-up window can be reduced based on this input. Additionally, when a drag input is provided to the opposite boundary area from one boundary area, the pop-up window can be closed.

Moreover, when a drag input (that is, input \textcircled{2}) is provided after one point in an internal area of the pop-up window is selected, the pop-up window can change its position on the basis of a drag length, as illustrated in FIG. 6A.

Additionally, the size of the pop-up window can be adjusted through an input (for example, input \textcircled{3}) such as pinch to zoom using two points corresponding to an internal area of the pop-up window.

A screen 620 represents a display in a multi-window form. The first application can be displayed in an area 622 and the second application can be displayed in an area 624. The area 622 and the area 624 can be separated by a border line 626, as illustrated in FIG. 6A.

When an input for moving the border line 626 is received from a user, the sizes of the area 622 and the area 624 can be adjusted. For example, when the border line 626 is moved to the right by a predetermined distance through an input such as a user touch or a stylus pen, an area where the first application is displayed can be enlarged and an area where the second application is displayed can be reduced. In this case, if a user moves the border line 626 to the right or left end position of the screen 620, an application displayed in a reduced area can be terminated. For example, if a user moves the border line 626 to the right end of the screen 620, the second application can be terminated and the first application can be displayed in a full screen.

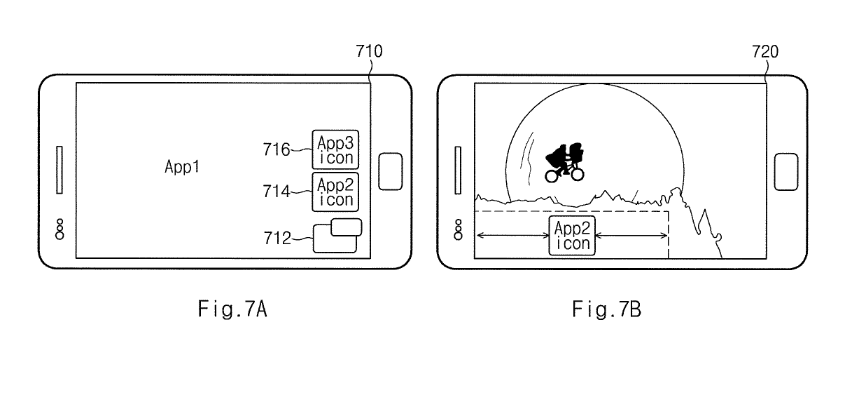

FIGS. 7A and 7B illustrate when an event icon is displayed according to embodiments of the present disclosure.

An event icon for a second application can be displayed in a predetermined area of a screen where a first application is running. That is, an event icon can be overlaid on the display of the first application and displayed. Or, in order to prevent part of the first application from being completely hidden by the event icon, the event icon can be displayed with a predetermined transparency. The event icon can be displayed alone but can be displayed together with another notification or control functions. For example, the event icon can be displayed in a predetermined area together with a notification in the form of a top bar or a pop-up notification in the center of the screen. Additionally, if the first application is an application displaying a control menu like a video playback application, the event icon can be displayed at a position other than an area where the control menu is displayed. As another example, the event icon can be displayed in a predetermined area regardless of the control menu area and then when the control menu is displayed, in order not to overlap an area where the control menu is displayed, the area of the event icon can be adjusted.

The event icon can be displayed together with a general control menu that does not relate to an application. For example, a pop-up play menu 712 can be displayed on a screen 710 and the event icon can be disposed above the pop-up play menu 712, as illustrated in FIG. 7A.

An event icon for a plurality of applications can be displayed. For example, while the first application is running on the screen 710, an event for the second application can occur. Before an input for the event icon for the second application is made, if an event for a third application occurs, an event icon 714 for the second application and an event icon 716 for the third application can be sequentially displayed on the screen 710. Of course, as mentioned above, the pop-up play menu 712 can be displayed together. If too many events occur while the selection of an event icon is not completed, event icons that have previously occurred can disappear from the screen 710 on the basis of the time elapsed or the number of generated event icons.

The event icon can be displayed at a proper position through the analysis of an image displayed by the first application. For example, a screen 720 represents a screen of an electronic device on which a scene from a movie is played. The electronic device can determine a proper position for displaying an event icon by analyzing a current image. As shown in FIG. 7B, the electronic device can determine a predetermined area of a black background space at the bottom of an image as an area for displaying an event icon and can display an occurring event icon at the center of a corresponding area or from the left/right. If a currently displayed image is deformed to the point where its identity is difficult to maintain, the event icons can be rearranged or maintain their initially generated positions in order not to add to the confusion of a user.

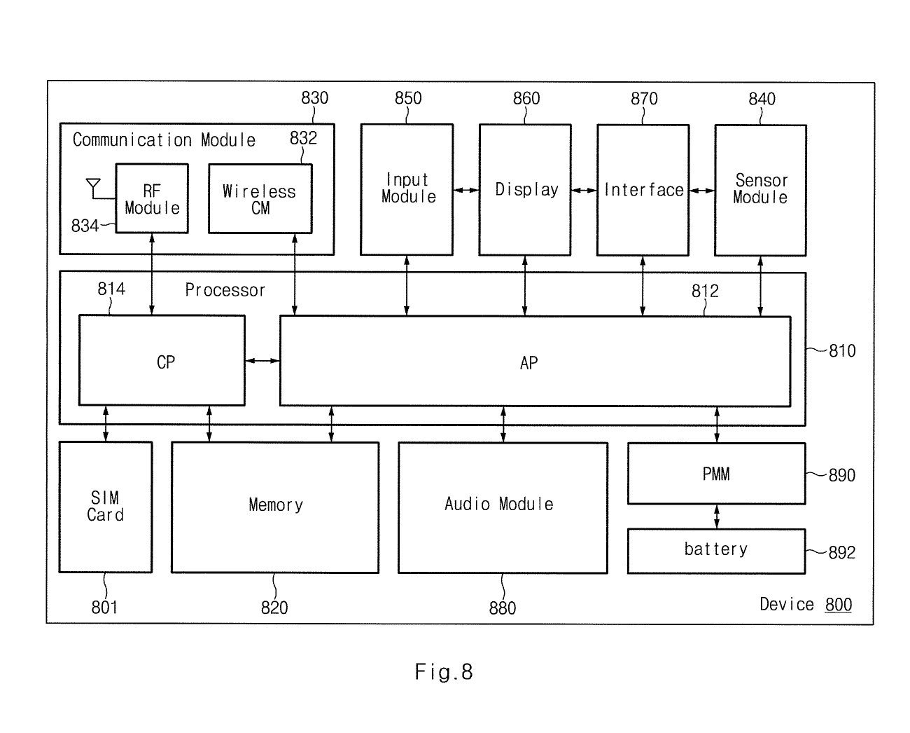

FIG. 8 is a view illustrating a structure of an electronic device according to an embodiment of the present disclosure.

Referring to FIG. 8, the electronic device 800 includes a processor 810, a memory 820, a communication module 830, a sensor module 840, an input module 850, a display 860, an interface 870, an audio module 880, a Power Management Module (PMM) 890, a battery 892, and a SIM card 801.

The processor 810 can include at least one application processor (AP) 812 and/or at least one communication processor (CP) 814. Although the AP 812 and the CP 814 included in the processor 810 are shown in FIG. 8, they can be included in different IC packages. According to an embodiment of the present disclosure, the AP 812 and the CP 814 can be included in one IC package.

The AP 812 can control a plurality of hardware or software components connected to the AP 812 by executing an operating system or an application program and can perform various data processing and operations with multimedia data. The AP 812 can be implemented with system on chip (SoC), for example. According to an embodiment of the present disclosure, the processor 810 can further include a graphic processing unit (GPU) (not shown).

The CP 814 can manage a data link in a communication between electronic devices connected to the electronic device 800 via a network and can convert a communication protocol. The CP 814 can be implemented with SoC. According to an embodiment of the present disclosure, the CP 814 can perform at least part of a multimedia control function. The CP 814 can perform a distinction and authentication of an electronic device in a communication network by using a subscriber identification module (for example, the SIM card 801), for example. Additionally, the CP 814 can provide services, for example, a voice call, a video call, a text message, or packet data, to a user.

Additionally, the CP 814 can control data transmission of the communication module 830. As shown in FIG. 8, components such as the CP 814, the power management module 890, or the memory 820 are separated from the AP 812, but according to an embodiment of the present disclosure, the AP 812 can be implemented including some of the above-mentioned components (for example, the CP 814).

According to an embodiment of the present disclosure, the AP 812 or the CP 814 can load commands or data, which are received from at least one of nonvolatile memory or other components connected thereto, into a volatile memory and can process them. Additionally, the AP 812 or the CP 814 can store data received from or generated by at least one of other components in a nonvolatile memory.

The SIM card 801 can be a card including a subscriber identification module and can be inserted into a slot formed at a specific position of an electronic device. The SIM card 801 can include unique identification information (for example, an integrated circuit card identifier (ICCID)) or subscriber information (for example, an international mobile subscriber identity (IMSI)).

The memory 820 can include an internal memory and/or an external memory. The internal memory can include at least one of volatile memories such as DRAM, SRAM, and SDRAM and nonvolatile memories such as one time programmable ROM (OTPROM), PROM, EPROM, EEPROM, mask ROM, flash ROM, NAND flash memory, and NOR flash memory. According to an embodiment of the present disclosure, the internal memory can be a solid state drive (SSD). The external memory can further include a flash drive such as a compact flash (CF) card, a secure digital (SD) card, a Micro-SD card, a Mini-SD card, an Xd card, or a Memory Stick. The external memory can be functionally connected to the electronic device 800 through various interfaces. According to an embodiment of the present disclosure, the electronic device 800 can further include a storage device (or storage medium) such as HDD.

The communication module 830 can include a wireless communication module 832 and/or an RF module 834. The wireless communication module 832 can include Wi-Fi, Bluetooth, GPS, or NFC, for example. The wireless communication module 832 can provide a wireless communication function by using a wireless frequency. In addition, the wireless communication module 832 can include a network interface (for example, a LAN card) or a modem for connecting the electronic device 800 to a network (for example, Internet, local area network (LAN), wire area network (WAN), telecommunication network, cellular network, satellite network, or plain old telephone service (POTS)).

The RF module 834 can be responsible for data communication such as RF signal transmission. The RF module 834 can include a transceiver, a power amp module (PAM), a frequency filter, or a low noise amplifier (LNA), for example. Moreover, the RF module 834 can further include components for transmitting/receiving electromagnetic waves on free space in a wireless communication, for example, conductors or conducting wires. According to an embodiment of the present disclosure, an antenna system can correspond to the RF module 834 or at least part of the RF module 834.

The sensor module 840 measures physical quantities or detects an operating state of the electronic device 800, thereby converting the measured or detected information into electrical signals. The sensor module 840 can include at least one of a gesture sensor, a gyro sensor, a pressure sensor, a magnetic sensor, an acceleration sensor, a grip sensor, a proximity sensor, a color sensor (for example, a RGB sensor), a bio sensor, a temperature/humidity sensor, an illumination sensor, and a ultra violet (UV) sensor. Additionally, the sensor module 840 can include an E-nose sensor, an electromyography (EMG) sensor, an electroencephalogram (EEG) sensor, or an electrocardiogram (ECG) sensor, an IR sensor, an iris sensor, or a fingerprint sensor. The sensor module 840 can further include a control circuit for controlling at least one sensor.

The input module 850 can include a touch panel, a (digital) pen sensor, a key, or an ultrasonic input device. The touch panel can recognize a touch input through at least one of a capacitive, resistive, infrared, or ultrasonic method, for example. Additionally, the touch panel can further include a control circuit. In the case of the capacitive method, both physical touch and proximity recognition are possible. The touch panel 252 can further include a tactile layer. In this case, the touch panel can provide a tactile response to a user.

The display 860 can include a panel, a hologram, or a projector. For example, a panel can be an LCD or AM-OLED. Or, the panel can be implemented to be flexible, transparent, or wearable, for example. The panel and the touch panel can be configured using one module. The hologram can show three-dimensional images in the air by using the interference of light. The projector can project light on a screen to display an image. The screen can be disposed inside or outside the electronic device 800. According to an embodiment of the present disclosure, the display 860 can further include a control circuit for controlling the panel, the hologram, or the projector.

The interface 870 can include a high-definition multimedia interface (HDMI), a USB, an optical communication terminal, or a D-sub terminal. Additionally, the interface 870 can include mobile high-definition link (MHL), SD card/multi-media card (MMC), or infrared data association (IrDA).

The audio module 880 can convert sound and electronic signals in both directions. The audio module 880 can provide sound information input or output through a speaker, a receiver, an earphone, or a mike.

The power management module 890 can manage the power of the electronic device 800. The power management module 890 can include a power management integrated circuit (PMIC), a charger integrated circuit (IC), or a battery or fuel gauge.

According to an embodiment of the present disclosure, the electronic device 800 can include a processor 810 including at least one of the CP 814 and the AP 812. The processor 810 can operate as a control unit for controlling an entire function of the electronic device 800. A first application can be executed by the processor 810 and can be displayed on the display 860.

In this state, an event for a second application can occur. This event can be a push alarm received by the communication module 830 and processed by the CP 814. Or, this event can be an alarm determined by the processor 810. An event icon indicating the occurred event can be displayed in an area of the display 860.

The electronic device 800 can receive a user input. A general user input can be performed by the input module 850. However, according to various embodiments, an input interface for a user input can be configured with an integrated touch panel and display 860. Or, the input interface can be implemented using various sensor modules 840. Additionally, the input interface can receive at least one of capacitive, resistive, and optical inputs using a stylus pen.

On the receipt of a user input for an event icon through an input interface, the processor 810 can display a first application in a first area of the display 860 and a second application in a second area of the display 860 through at least one of the above methods.

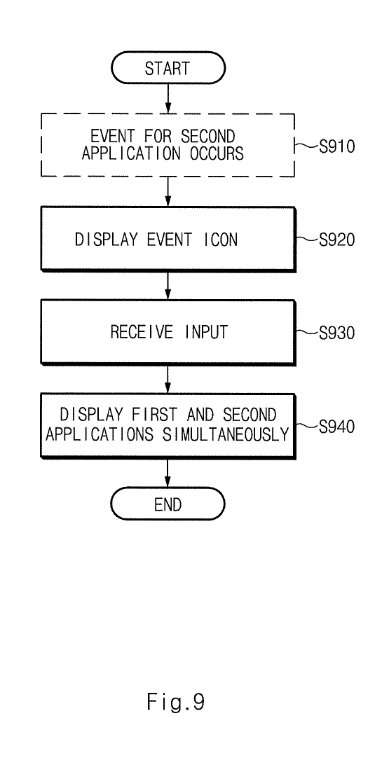

FIG. 9 is a flowchart illustrating a screen switching method according to an embodiment of the present disclosure. In relation to the description below, overlapping contents are omitted.

At the beginning, an electronic device executes a first application. When an event for a second application occurs in this state in operation S910, an even icon indicating that the event for the second application occurs may be displayed in an area of a screen of the electronic device in operation S920. Then, when a user input for the event icon is received in operation S930, in response to the user input, the second application can be simultaneously displayed while the display of the first application is not terminated.

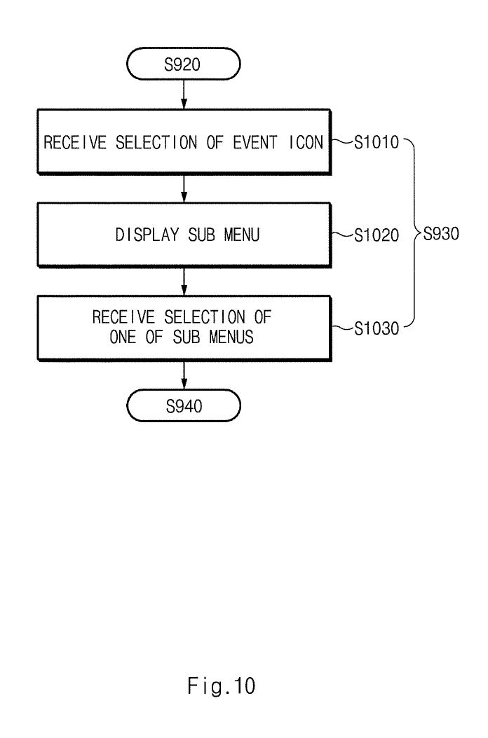

FIG. 10 is a flowchart illustrating a user input receiving method according to an embodiment of the present disclosure. The flowchart of FIG. 10 can be understood as a detailed flowchart of operation S930 shown in FIG. 9.

Referring to FIG. 10, after an event icon is displayed in operation S920, the electronic device receives a selection on an event icon in operation S1010. This selection can be a touch on and off input or can be an input for maintaining a touch state. Or, this selection can be a state in which a stylus pen spaced a predetermined distance from a screen of a device and indicating an event icon.

In response to the selection input, a sub menu can be displayed around an event icon in operation S1020. This sub menu can include at least one of a pop-up window menu, a multi-window menu, and other pre-defined menus.

Then, when a user input for selecting one from the sub menu is received in operation S1030, in response to the user input, the second application can be simultaneously displayed while the display of the first application is not terminated in operation S940.

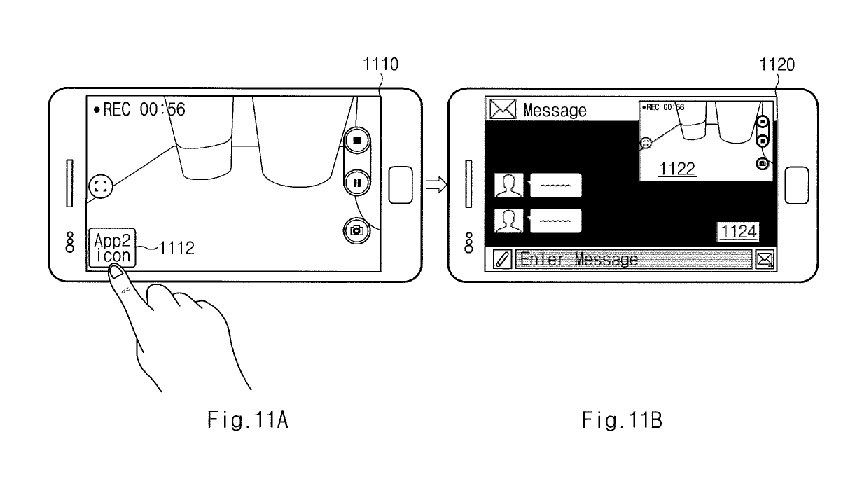

FIGS. 11A and 11B illustrate screens when an event occurs during the execution of a video capturing application according to an embodiment of the present disclosure.

Referring to FIG. 11A, a video capturing application such as a camcorder application is displayed on a screen 1110. That is, an image recorded by a camera module of an electronic device is displayed on the screen 1110.

In addition to an image recorded by a camera module, various control menus supporting a video capturing application can be displayed on the screen 1110. For example, various control menus such as ‘recording stop’, ‘recording pause’, ‘switching to picture capturing’, and ‘snapshot capturing during video recording’ can be displayed in a predetermined area. Furthermore, the letters “REC” indicating a recording state and a time display indicating a recording progressed time can be displayed together.

Then, when the electronic device receives a new message, that is, an event for a second application occurs, a message event icon 1112 indicating that a message is received at a predetermined position is generated. The message event icon 1112 can be displayed in an area that does not overlap a control menu. Additionally, when control menus are displayed (for example, a user touches a predetermined portion of an image being recorded), the message event icon 1112 can be displayed simultaneously, and when the control menus disappear (for example, a predetermined time elapses without receiving an input while the control menus are displayed), the message event icon 1112 can disappear simultaneously.

Then, a user input for the message event icon 112 is received, in response to this, the electronic device moves an image displayed by a video capturing application to a predetermined size of pop-up window and can display a message application simultaneously while maintaining capturing/recording as it is. Of course, as mentioned above, a video capturing application and a message application can be displayed in a multi-window form.

According to an embodiment of the present disclosure, in relation to an application such as camcorder shooting that is not supposed to stop in the middle of execution, an important event or notification can be checked simply while the execution of the application is maintained.

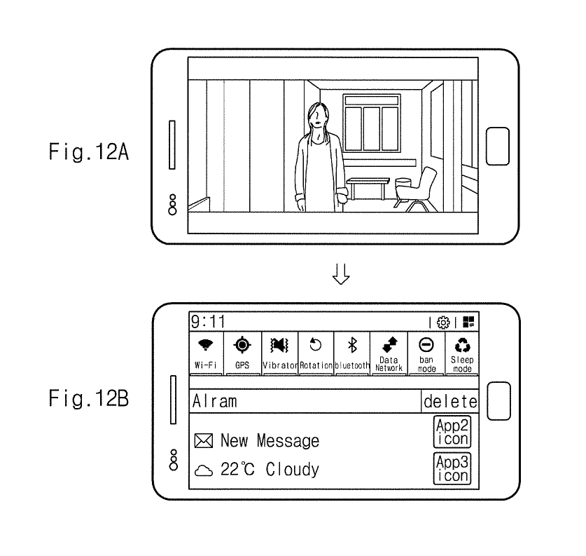

FIGS. 12A and 12B illustrate the screen switching operation according to another embodiment of the present disclosure. During the execution of an application, when an event for at least one another application occurs, as a new message notification and weather information are provided during video playback, a user can allow a toggle screen to be displayed through a pre-defined input. For example, a toggle screen can be displayed as shown in FIG. 12B through an input such as a drag from the top end of a screen toward the top direction or a drag from the bottom end of a screen toward the top direction. In a toggle screen, a notification for the least one another application can be displayed in an event icon form or a desired application and an already running application can be executed simultaneously by selecting the event icon.

According to various embodiments of the present disclosure, a plurality of applications are displayed simultaneously by minimizing a user input without stopping a running application.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A screen switching method in an electronic device, the method comprising:
displaying an execution screen of a first application on a screen;
displaying an event icon indicating an event occurring in association with a second application, on a portion of the first execution screen where the first application is being executed;
receiving an input for the event icon; and
displaying an execution screen of the first application and an execution screen of the second application simultaneously on the screen, in response to the input.

2. The method according to claim 1, wherein the execution screen of the second application is in a pop-up window over the execution window of the first application.

3. The method according to claim 1, wherein the execution screen of the second application is in a split window, wherein the screen is split into the execution screen of the first application and the execution screen of the second application.

4. The method according to claim 1, wherein a type of the execution screen of the second application is determined on the basis of at least one of a user input frequency of the first application and a number of objects on the execution screen of the first application.

5. The method according to claim 1, wherein the execution screen of the second application is in a pop-up window when the input for the event icon is a tapping on the event icon.

6. The method according to claim 1, wherein the execution screen of the second application is in a split window when the input for the event icon is a dragging the event icon.

7. The method according to claim 6, wherein a split border is placed on a point where the dragging of event icon is released.

8. The method according to claim 1, wherein the input for the event icon is a voice input instructing a type of the execution screen of the second application.

9. The method according to claim 1, where receiving the input for the event icon comprises:
receiving a first input for selecting the event icon;
displaying a sub-menus comprising at least a pop-up window and a split window, adjacent to the event icon; and
receiving a second input for selecting one menu from the sub-menus.

10. The method according to claim 2, wherein a size or a position of the displayed pop-up window form is adjusted according to a user input.

11. The method according to claim 3, wherein a split ratio of the screen is adjusted according to a user input.

12. The method according to claim 1, wherein displaying the event icon comprises:
analyzing an image displayed by the first application; and
displaying the event icon in an area determined based on the analysis.

13. An electronic device comprising:
a screen configured to display an image or a video; and
a controller configured to:
cause the screen to display an execution screen of a first application on a screen;
cause the screen to display an event icon indicating an event occurring in association with a second application, on a portion of the first execution screen where the first application is being executed;
receive an input for the event icon; and
cause the screen to display an execution screen of the first application and an execution screen of the second application simultaneously on the screen, in response to the input.

14. The electronic device according to claim 12, wherein the execution screen of the second application is in a pop-up window over the execution window of the first application.

15. The electronic device according to claim 12, wherein the execution screen of the second application is in a split window, wherein the screen is split into the execution screen of the first application and the execution screen of the second application.

16. The electronic device according to claim 12, wherein a type of the execution screen of the second application is determined on the basis of at least one of a user input frequency of the first application and a number of objects on the execution screen of the first application.

17. The electronic device according to claim 12, wherein the execution screen of the second application is in a pop-up window when the input for the event icon is a tapping on the event icon.

18. The electronic device according to claim 12, wherein the execution screen of the second application is in a split window when the input for the event icon is a dragging the event icon.

19. The electronic device according to claim 14, wherein a split border is placed on a point where the dragging of event icon is released.

20. The electronic device to claim 12, where the controller is further configured to:
receive a first input for selecting the event icon;
cause the screen to display a sub-menus comprising at least a pop-up window and a split window, adjacent to the event icon; and
receive a second input for selecting one menu from the sub-menus.
